(19) United States
(12) Patent Application Publication
(10) Pub. No.: US 2002/0062210 A1
(43) Pub. Date: May 23, 2002

(54) Voice input system for indexed storage of speech

(75) Inventor: Toshihiko Hamada, Tokyo (JP)

Correspondence Address: Michael P. Dunnam, Esq, WOODOCK WASHBURN KURTZ, MACKIEWICZ & NORRIS, One Liberty Place, 46th Floor, Philadelphia, PA, 19103, US

(73) Assignee: TEAC Corporation

(21) Appl. No.: 10/001,474

(22) Filed: Nov. 1, 2001

(30) Foreign Application Priority Data
Nov. 20, 2000 (JP) 2000-353435

(51) Int. Cl. G10L 15/26; G10L 15/00

(52) U.S. Cl. 704/235

(57) ABSTRACT

A voice-input recording system is disclosed which includes a vocal-to-textural converter for translating, with the aid of a speech recognition program, a speech signal into speech data in a textural format. The textural speech data is then combined with incremental date-and-time data, with the increments of the date-and-time data assigned as addresses to successive segments of the speech data. The speech data is recorded together with field separators interposed one between each speech data segment and the date-and-time data increment assigned thereto, and with record separators interposed one between each combination of one speech data segment and one field separator and one date-and-time data increment and another such combination.

### BACKGROUND OF THE INVENTION

This invention relates to a voice input device for vocally inputting data into a system such as, typically, a personal computer system, and more particularly to a novel voice input system capable of translating speech into an electric data signal in textural form and combining the speech text with incremental date-and-time information, for ease of subsequent accessing to any desired part of the speech stored.

Voice input devices have been suggested and used for inputting data and system commands into computer systems, in either substitution for, or supplementation of, other input devices which are mostly more conventional in nature. Such voice input equipment involves use of some form of speech recognition, various types of which have also been proposed and put to practice. Japanese Unexamined Patent Publication Nos. 10-31576 and 2000-67064 are hereby cited as teaching voice input systems comparable to the instant invention. These prior art systems are explicitly designed for recording and compilation of evasive ideas that may lead to inventions, and for corporate dealing with customer complaints, respectively.

One of the problems with the vocal inputting of data into computer systems is how to access to desired parts of the speech that has been recorded, without, of course, going through the entire recording.

### SUMMARY OF THE INVENTION

The present invention seeks to most efficiently and economically index the speech just as the same is being input to a computer system or the like, and hence to make it possible later to readily access to any desired part of the speech recorded.

Briefly, the invention concerns a voice input system using speech for inputting data into a system, comprising: (a) a vocal-to-textural converter for translating an audio-frequency speech signal into speech data in a textural format; (b) a source of date-and-time data which is incremented every predefined length of time; and (c) a text mixer for assigning the increments of the date-and-time data from the source thereof to successive segments of the speech data from the vocal-to-textural converter.

An example of the source of date-and-time data is a clock or timepiece that is customarily incorporated in a computer to provide date-and-time data which is incremented second by second. In one preferred embodiment of the invention to be disclosed subsequently, each one-second increment of the date-and-time data is assigned to one segment of the speech data; that is, the speech data is segmented at one-second intervals for addressing. Since different, but consecutive, date-and-time data are assigned to successive one-second segments of the speech data, any speech segments are readily accessible using the date-and-time increments as addresses.

Another preferred embodiment of the invention employs a text analyzer for grammatically and idiomatically analyzing the speech data output from the vocal-to-textural converter. The text analyzer divides the speech data into segments that are grammatically or idiomatically meaningful and which as a consequence are unequal in length. Although the increments of the date-and-time data assigned to such speech data segments are also correspondingly unequal in length, the speech data so analyzed, segmented, and indexed are better understandable and easier of editing.

In still another preferred embodiment the present invention is applied to a television news program management system comprising a video tape recorder and, preferably, a personal computer system appropriately interfaced with the VTR for remotely controlling the same, in addition to a voice input device of largely foregoing construction. As a prerecorded television news program is played back by the VTR, the audio signal of the program is directed into the voice input device thereby to be segmented, indexed, and stored. The voice input device in this application is preferably equipped with manual input means, such as digit keys, for presetting and initializing the date-and-time source at a desired date and time such as when the program was, or is to be, broadcast. The date-and-time data to be assigned to the segments of the news narration can then be incremented from the preset date and time for convenience in editing by the personal computer system.

The above and other objects, features and advantages of this invention will become more apparent, and the invention itself will best be understood, from a study of the following description and appended claims, with reference had to the attached drawings showing the preferred embodiments of the invention.

### BRIEF DESCRIPTION OF THE DRAWINGS

FIG. 1 is a block diagram of a preferred form of voice-input recording system embodying the principles of this invention;

FIG. 2 is a table explanatory of how the increments of the date-and-time data are assigned to segments of the speech data in the voice-input recording system of FIG. 1;

FIG. 3 is a block diagram of another preferred form of voice-input recording system according to the invention, the system including a text analyzer for dividing the speech into more meaningful segments;

FIG. 4 is a table explanatory of how the increments of the date-and-time data are assigned to the meaningful speech segments in the voice-input recording system of FIG. 3;

FIG. 5 is a schematic illustration, partly block-diagrammatic, of still another preferred form of voice-input recording system as applied to the management of television news programs; and

FIG. 6 is a table explanatory of how the increments of the date-and-time data are assigned to the segments of news narration in the television news management system of FIG. 5.

### DESCRIPTION OF THE PREFERRED EMBODIMENTS

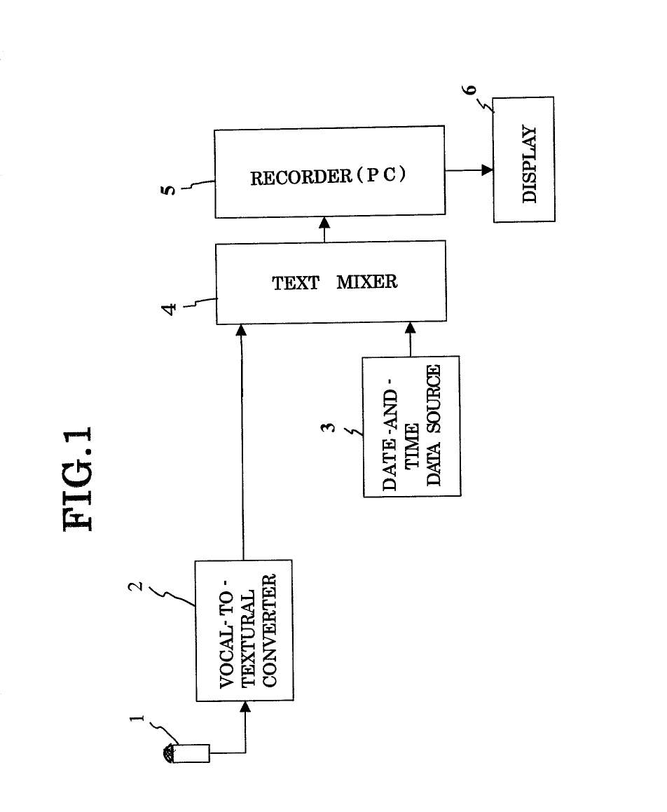

The voice input device according to the invention lends itself to use in combination with various known or suitable components in a variety of applications. In its perhaps simplest form the invention may be embodied in the voice-input recording system diagramed in FIG. 1. This recording system includes a microphone 1, the familiar transducer capable of translating speech in a natural language into an electric audio-frequency signal.

Connected to the microphone 1, a vocal-to-textural converter 2 may take the form of a part of a computer with a built-in speech recognition program, interpreting the voice input to determine its data content and converting the input into data in a textural format. The speech recognition program translates the natural-language input into textural data practically in real time by referring to the speech dictionary and work dictionary appended thereto. The textural data produced by the vocal-to-textural converter 2 is herein referred to as the speech text. A speech recognition program that most suits the purposes of the instant invention may be chosen from among a wide variety of such programs available today. No further elaboration on this subject is considered necessary.

At 3 in FIG. 1 is shown a date-and-time data source providing data in textural form indicative of the present date and time, which data is incremented second by second. This output from the date-and-time data source 3 is herein termed the date-and-time text in contradistinction from the speech text produced by the vocal-to-textural converter 2. In practice the date-and-time text may take the form of the time code of the known measurement-purpose data recorder, or the output from the clock customarily incorporated in a personal computer.

The speech text from the vocal-to-textural converter 2 and the date-and-time text from its source 3 are both directed into a text mixer 4 whereby the two inputs are combined according to the novel concepts of this invention. More specifically, the successive increments of the date-and-time text are assigned to successive segments of the incoming speech text.

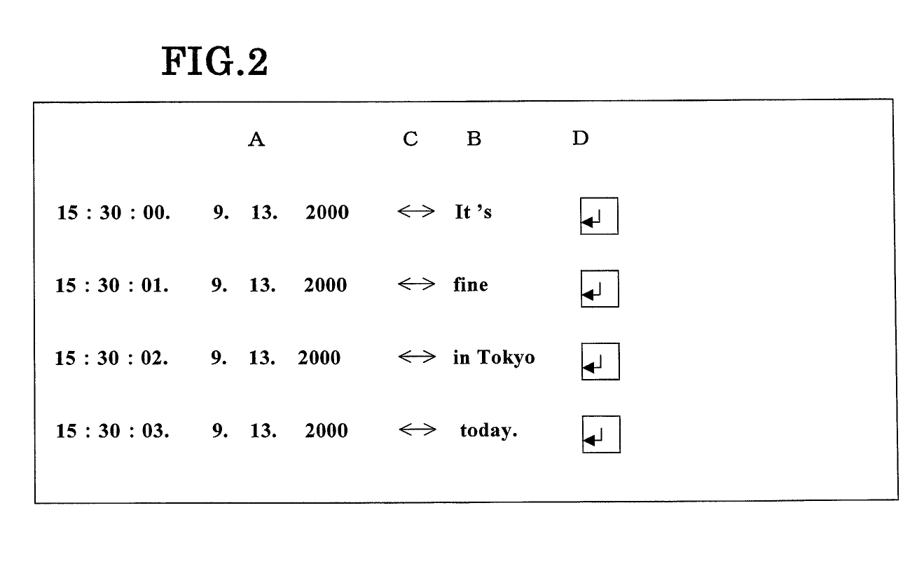

FIG. 2 is a table explanatory of how the date-and-time text is combined with the speech text by the text mixer 4 of this particular embodiment of the invention. At column A of this table are shown four sequential examples of the incremental date-and-time text, from “15:30:00. 9. 13. 2000,” standing for “15 o'clock, 30 minutes flat, Sep. 13, 2000,” to “15:30:03, 9. 13. 2000,” standing for “15 o'clock, 30 minutes, three seconds, Sep. 13, 2000.” During this period of time the speech text, “It's fine in Tokyo today,” is shown input at column B. This speech text is shown divided into four segments, “It's,” “fine,” “in Tokyo,” and “today,” which segments are combined with the respective increments, seconds, of the date-and-time text via field separators C. These field separators are shown as double-headed arrows and in practice may be the tab code “09H.” Further, as indicated at column D in the same table, the four speech text segments are separated by the record separators.

The field separators C should be a character, symbol or mark that does not appear in, and so are clearly discernible from, natural-language speech, preferred examples being the comma and the tab, in addition to the double-headed arrow shown. A preferred example of record separator D is the familiar end-of-line marker used in text editors and work processing systems.

Most possibly, in the practice of the invention, not all the speech text may be clearly divisible at the divisions of the date-and-time text, but words or phases of the speech text may extend over the date-and-time text divisions. In such cases the speech text may be made to be divided either before or after the words or phrases extending over the date-and-time text divisions.

The text mixer 4 has its output connected to a recorder 5 which in practice may take the form of a hard or a flexible magnetic disk drive of well known construction such as those used as peripheral data storage devices of personal computers. Preferably, the output from the text mixer 4, the combination of the speech text and the date-and-time text, should be delivered in the form of text streams via a suitable interface such as the RS-232C of the Electronic Industries Association standards. The text streams from the text mixer 4 may be recorded in the form of log files by the recorder 5 using a personal computer communication program. As desired, the vocal-to-textural converter 2, the date-and-time text source 3 and the text mixer 4 may all be built into the personal computer unit having the recorder 5 as a peripheral.

As an ancillary feature of the invention, a display 6 is shown connected to the recorder 5 for visual indication of the indexed text that has been recorded. The showing of FIG. 2 represents an example of what is exhibited on the display 6. In cases where the recorder 5 is a peripheral of a personal computer, the display 6 can be that of that personal computer system.

Combined with the date-and-time text as above, the speech text may be stored in the recorder 5 as a plain text file. The stored plain text files lend themselves to easy editing or processing with text editors, word processing systems, database software, etc. As the speech text is segmented second by second, and each segment combined with its own increment, or segment again, of the date-and-time text, in this particular embodiment of the invention, the date-and-time data accompanying any desired parts of the speech text may be readily ascertained, or any desired parts of the speech text readily accessed by specifying their date-and-time increments as addresses, using a commercial indexing tool. Not only interactive application programs such as database software, text editors, and word processing programs, but such noninteractive text indexing tools as the familiar UNIX (trademark) Grep, Sed, Awk, and Perl may all be used for accessing the stored text.

### Second Form

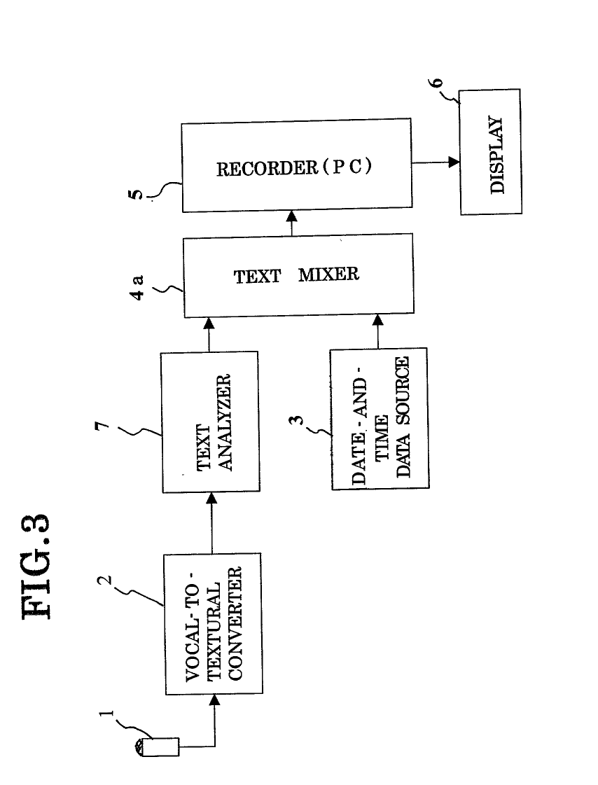

The speech text was segmented second by second, without regard to its grammar or sentence structures, in the previous embodiment of the invention. The embodiment of FIG. 3 incorporates a text analyzer 7 in anticipation of cases where more intelligible speech segmentation is desired. Connected between the vocal-to-textural converter 2 and a text mixer 4a of slightly modified construction, the text analyzer 7 analyzes the incoming speech text in reference to the dictionary stored therein and puts out each sentence as divided into a series of segments each consisting of a whole word or phrase. The sentence segments so divided are, of course, more grammatically or idiomatically meaningful, more understandable, and easier of subsequent handling by the user, than those divided at constant time intervals as in FIG. 2.

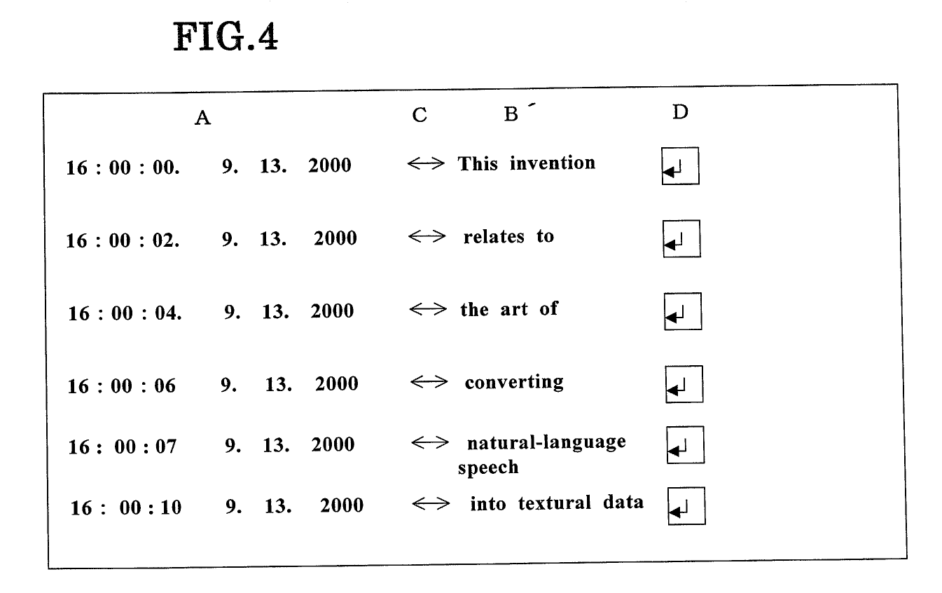

At column B′ in FIG. 4 is shown an example of sentence segmented by the text analyzer 7. This sentence is shown divided into six segments which of necessity are unequal in length. The text analyzer 7 puts out each sentence of the speech text with segment separators inserted between its segments. A preferred example of segment separator is the semicolon. Thus, for instance, the output from the text analyzer 7 may be: “This invention; relates to; the art of; converting; natural-language speech; into textural data;.”

Inputting each segmented sentence from the text analyzer 7, the text mixer 4a derives from the incremental date-and-time text from its source 3 the date-and-time increment that agrees in time with each segment separator of the input sentence. Namely, the text mixer 4a mixes the speech data and the date-and-time data in such a manner that the increments of the date-and-time data are assigned to the segment separators. Thus, in FIG. 4, the date-and-time text increment “16:00:00. 9. 13. 2000” is assigned to the first sentence segment “This invention,” the increment “16:00:02. 9. 13. 2000” to the second sentence segment “relates to,” the increment “16:00:04. 9. 13. 2000” to the third segment “the art of,” the increment “16:00:06. 9. 13. 2000” to the fourth segment “converting,” the increment “16:00:07. 9. 13. 2000” to the fifth segment “natural-language speech,” and the increment “16:00:10. 9. 13. 2000” to the sixth segment “into textural data.”

The date-and-time increments are inserted at the beginnings of the successive sentences, right before the first segment thereof, in addition to between the segments of each sentence. Further, as indicated also in FIG. 4, field separators C are interposed between the date-and-time text increments A and the speech text segments B′, and the record separators or end-of-line markers D recorded after the speech text segments. This FIG. 4 output from the text mixer 4a is directed into the recorder 5 for storage, as well as into the display 6 for visual indication.

### Third Form

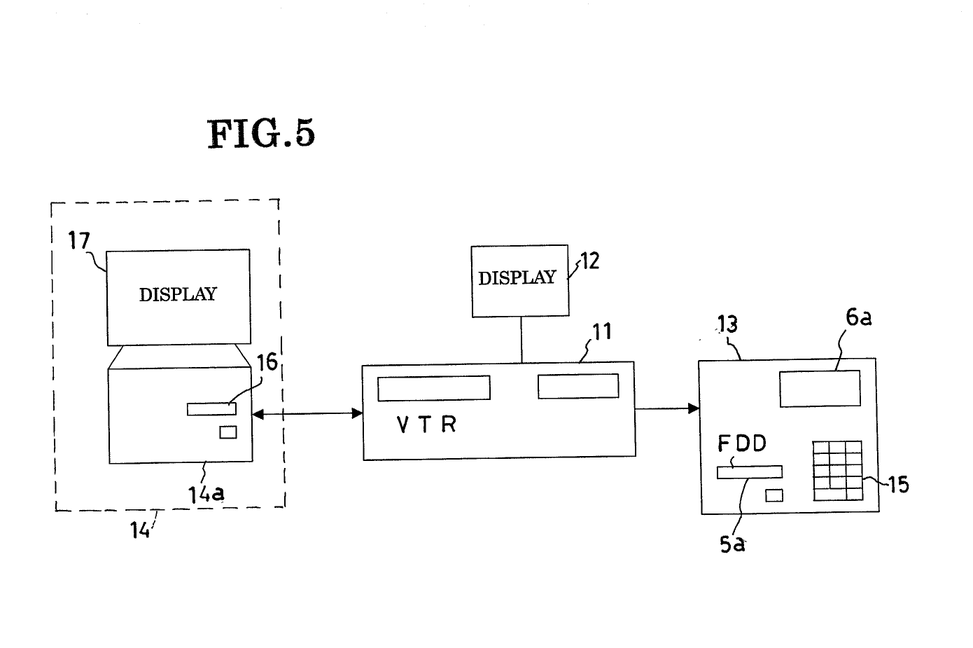

In FIG. 5 is shown the voice input system of this invention applied to the indexed storage and editing of the announcements of television news programs. The illustrated news management system, so to say, comprises: (a) a video tape recorder 11 as a playback device for playing back television news programs; (b) a display or television set 12 connected to the VTR 11 for visibly representing the news program being played back; (c) a voice-input recording device 13 connected to the VTR 11 for indexed storage of the announcement or audio signal of the news program being played back; and (d) a personal computer system 14 for remotely controlling the VTR 11.

The VTR 11 is for playback of news programs prerecorded on video tape cassettes of familiar design. Of the standard audio and video signals of each television news program thus played back, only the audio signal is sent directly to the voice-input recording device 13 thereby to be translated into speech text, combined with date-and-time text, and recorded as in the FIG. 1 system. Thus the voice-input recording device 13 is understood to comprise equivalents for the vocal-to-textural converter 2, FIG. 1, the date-and-time text source 3, and the text mixer 4, in addition to a flexible magnetic disk drive 5a as the recorder 5, a liquid-crystal display 6a, and a digit-key input device 15. The equivalent for the date-and-time text source 3 in the voice-input recording device 13 is explicitly designed to permit initialization at any arbitrary date and time. Broadly, however, the device 13 is closely akin to the FIG. 1 system, so that the components of the latter will be referred to, with use of the same reference characters as in FIG. 1, in the following description of the FIG. 5 embodiment.

In use of the FIG. 5 news management system the audio signal of the news program played back by the VTR 11 is to be converted into speech text, then combined with date-and-time text, and then stored in the FDD 5a. Preliminary to the inputting of the news audio signal, however, the date-and-time text source 3 may be initialized at the date and time when the program was, or is to be, broadcast. The operator may initialize the date-and-time text source 3 through the digit-key input device 15 while watching the display 6a. So preset, the date-and-time text source 3 will put out the date-and-time text as the lapse of time from the preset date and time. The lapse of time is measured, of course, from the commencement of the delivery of the audio signal from VTR 11 to voice-input recording device 13.

As has been set forth with reference to FIG. 1, predetermined increments of the date-and-time text will be combined with successive segments of the audio signal delivered from VTR 11 to voice-input recording device 13. The date-and-time text may be added to the audio signal second by second as in FIG. 2 or, in light of the fluency of news casters in general, every five seconds.

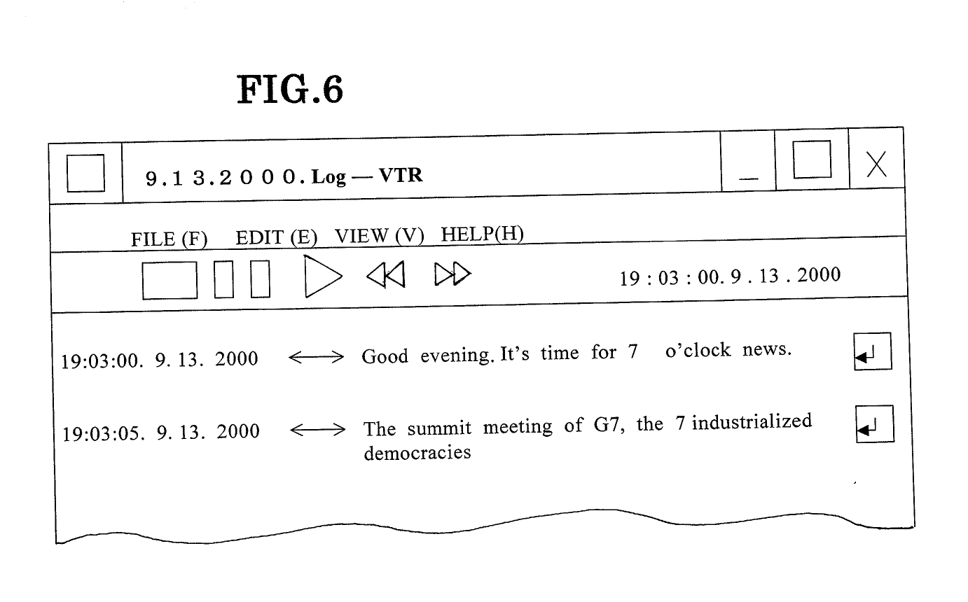

The flexible magnetic disk, not shown, on which has been stored the news program by the voice-input recording device 13 may be loaded in the FDD 16 of the computer system 14. FIG. 6 shows an example of what is exhibited on the display 17 of the personal computer system 14 upon retrieval of the news audio signal from the flexible magnetic disk. It will be seen that the date-and-time text has been preset at 19 o'clock, three minutes flat, Sep. 13, 2000. The speech text is shown divided into two segments, “Good evening. It's time for seven o'clock news,” and “The summit meeting of G7, the seven industrialized democracies.” To these speech text segments are assigned the date-and-time text increments “19:03:00. 9. 13. 2000” and “19:03:05. 9. 13. 2000,” respectively.

With reference back to FIG. 5 it is understood that the computer unit 14a of the personal computer system 14 is connected to the VTR 11 via the RC-232C interface or the like. The computer unit 14a is conventionally equipped with an FDD 16 and has a display 17. It is also understood that the computer unit 14a is preprogrammed for remotely controlling the VTR 11, and that this VTR is constructed to permit access to any parts of the recorded news program on the basis of the date-and-time addresses specified by the computer system 14.

In use of the news management system constructed as in the foregoing, the disk, not shown, on which has been stored the news program by the voice-input recording device 13 may be loaded in the FDD 16 of the computer system 14. The VTR remote control program installed on the computer system 14 may then be informed of the text file retrieved from the unshown disk. Thereupon the desktop of the remote control program will appear on the screen of the display 17, as illustrated in FIG. 6. It will be noted from this figure that the desktop shows, immediately under the menu bar, the standardized symbols of the buttons for operating the VTR 11. Underlying these symbols are the first several segments of the speech text of the recorded news program, together with the five-second increments of the date-and-time text assigned to the respective speech segments.

Then, following the insertion into the VTR 11 of the same tape cassette from which the audio signal of the news program was previously sent to the voice-input recording device 13, the operator may click the “play” button on the screen of the display 17. The “play” command will be sent from computer 14a to VTR 11, and from the latter to the former will be sent the data indicative of the lapse of playing time, by which is meant the absolute time indicating the recording time of each segment of the news. Inputting the lapse of the playing time from the VTR, the computer may determine the date-and-time information in the VTR by adding the playing time of the VTR to the initial date and time of the speech text.

As will be better understood by referring to FIG. 6 again, the successive lines of the news text segments shown on the display 17 will either change in color, blink, or flash when the date-and-time increments of these text segments are notified from the VTR 11. For instance, when the date-and-time increment “19:03:00. 9. 13. 2000” is sent from the VTR 11, either this date-and-time increment or the speech text segment, “Good evening. It's time for seven o'clock news,” or both will change in color. The operator is thus visually informed of the progress of playback in the VTR 11.

The FIG. 5 news management system makes it possible to monitor the video and audio signals of any desired part of the news program recorded in the tape cassette loaded in the VTR 11, merely by specifying the corresponding speech text segment. The operator may point the cursor at the desired speech text segment on the display screen and double-click the mouse, thereby causing the date-and-time text increment of that speech text segment to be sent to the VTR 11. Thereupon the VTR will compare the input date-and-time text increment with the recorded date-and-time information and start playing back the tape at the desired part of the recording.

There may be cases where the tape cassette loaded in the VTR has only information on the lapse of time from the commencement of recording or on the running time of the tape. In such cases the operator may manipulate the keyboard, not shown, or other input device of the computer system 14 to subtract the initial date and time setting from the date-and-time text increment that has been assigned to the desired speech text segment, preparatory to delivery to the VTR 11. For instance, instead of “19:03:05. 9. 14. 2000,” the time data “00:00:05” may be sent to the VTR 11.

It is also possible to edit the speech text on the display screen through the computer system 14 for greater ease of indexing. For instance, the speech test segment, “Good evening. It's time for seven o'clock news,” may be edited into “seven o'clock news.” Further, if the recorded news program is yet to be broadcast, possible misreadings of the manuscript may be corrected on the display screen by way of reference in correcting the recording on the tape.

### Possible Modifications

Notwithstanding the foregoing detailed disclosure, it is not desired that the present invention be limited by the exact showing of the drawings or the description thereof. The following, then, is a brief list of possible modifications or alterations of the illustrated embodiments which are all considered to fall within the scope of the invention:

1. The present invention is applicable to a variety of cases where a vocal recording is retrieved from some record medium and re-recorded on some other medium together with date-and-time addresses, one such case being reflected in the FIGS. 5 and 6 embodiment. In such cases the recording may be reproduced several times as fast as the standard speed, and combined with the date-and-time text that is incremented at the same high speed. Such high speed mixing of the speech text and date-and-time text requires, of course, matching equipment designed for such high speed operation.

2. Possible grammatical and idiomatic errors in the speech may be corrected either before or after the assignment of the date-and-time increments thereto. Such error correction need not necessarily be in real time.

3. The voice-input recording system according to the invention may be put to use in conjunction with motion-picture file servers on the Internet. Each file may have its speech text indexed as taught by the invention for instant reproduction of any desired motion picture.

4. The voice-input device according to the invention may be built into a VTR, possibly with use of the time code on the tape as the date-and-time text.

5. The voice-input device according to the invention may also be built into a video camera. The speech text files produced by the camera may be furnished with any pertinent data (e.g. date of shooting, name of the cameraman, and location) concerning the video recordings and registered to an indexing engine so that the video files may be readily accessed and retrieved out of a huge video library.

What is claimed is:

1. A voice input system using speech for inputting data into a system, comprising:
(a) a vocal-to-textural converter for translating an audio-frequency speech signal into speech data in a textural format;
(b) a source of date-and-time data which is incremented every predefined length of time; and
(c) a text mixer for assigning the increments of the date-and-time data from the source thereof to successive segments of the speech data from the vocal-to-textural converter.

2. The voice input system of claim 1 further comprising a recorder for recording the speech data together with the date-and-time data increments assigned to the successive segments of the speech data.

3. The voice input system of claim 2 further comprising a display for visually indicating the successive segments of the speech data together with the date-and-time data increments assigned thereto.

4. The voice input system of claim 1 wherein the date-and-time data is put out from the source in a textural format.

5. The voice input system of claim 1 wherein the vocal-to-textural converter is to be connected to a playback device for inputting therefrom an audio-frequency signal retrieved from a record medium, and wherein the date-and-time data source provides the date-and-time data starting from the date and time the audio-frequency signal was recorded on the record medium.

6. A voice input system using speech for inputting data into a system, comprising:
(a) a vocal-to-textural converter for translating an audio-frequency speech signal into speech data in a textural format;
(b) a text analyzer for analyzing the speech data and dividing the same into a series of segments each consisting of one or more whole words or phrase;
(c) a source of date-and-time data which is incremented every predefined length of time; and
(d) a text mixer for assigning the increments of the date-and-time data from the source thereof to the successive segments of the speech data from the text analyzer.

7. A system for management of information, comprising:
(a) a playback device for playing back a prerecorded information including an audio signal;
(b) a vocal-to-textural converter connected to the playback device for translating the audio signal of the information being played back, into speech data in a textural format;
(c) a source of date-and-time data which is incremented every predefined length of time;
(d) a text mixer for assigning the increments of the date-and-time data from the source thereof to successive segments of the speech data from the vocal-to-textural converter; and
(e) a recorder for recording the speech data together with the date-and-time data increments assigned to the successive segments of the speech data.

8. The information management system of claim 7 further comprising input means connected to the source of date-and-time data for initializing the same at a desired date and time.

9. The information management system of claim 7 further comprising a personal computer system interfaced with the playback device for remotely controlling the same.

10. A voice-input recording method for indexed recording of speech, which method comprises:
(a) translating an audio-frequency speech signal into speech data in a textural format;
(b) providing date-and-time data which is incremented every predefined length of time;
(c) mixing the speech data and the date-and-time data in such a manner that the increments of the date-and-time data are assigned to successive segments of the speech data; and
(d) recording the speech data together with the date-and-time data increments assigned to the successive segments of the speech data.

11. The voice-input recording method of claim 10 wherein the textural speech data is analyzed and divided into a series of segments each consisting of one or more whole words or phrase, and wherein the increments of the date-and-time data are subsequently assigned to the successive segments of the speech data.

12. The voice-input recording method of claim 10 wherein the speech data is recorded with field separators interposed one between each speech data segment and the date-and-time data increment assigned thereto.

13. The voice-input recording method of claim 12 wherein the speech data is recorded with record separators interposed one between each combination of one speech data segment and one field separator and one date-and-time data increment and another such combination.

14. The voice-input recording method of claim 10 wherein the date-and-time data is indicative of present time.

15, The voice-input recording method of claim 10 wherein the date-and-time data is indicative of the lapse of time from an arbitrarily determined date and time.
